(19) United States
(12) Patent Application Publication
(10) Pub. No.: US 2007/0029566 A1
(43) Pub. Date: Feb. 8, 2007

(54) Color filter substrate manufacturing method

(75) Inventors: Satoru Katagami, Hara-mura (JP); Kunio Maruyama, Misato-mura (JP); Keiji Takizawa, Toyoshima-machi (JP); Hisashi Aruga, Fujimi-machi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/543,135

(22) Filed: Oct. 5, 2006

Related U.S. Application Data
(62) Division of application No. 10/933,480, filed on Sep. 3, 2004.

(30) Foreign Application Priority Data
Sep. 10, 2003 (JP) JP 2003-318437

(51) Int. Cl. H01L 33/00

(52) U.S. Cl. 257/98

(57) ABSTRACT

A color filter substrate has a transmissive portion through which light rays are transmitted and a reflective portion on which light rays are reflected. A color filter substrate manufacturing method includes providing a transmissive base, forming a foundation layer over the transmissive base such that a depressed portion is formed at the transmissive portion, forming a reflective film over the foundation layer so as to have an opening at the transmissive portion, forming banks over the reflective film so as to define a deposit region, and forming a coloring element over the reflective film with droplet discharge onto the deposit region defined by the bank.

### CROSS-REFERENCE TO RELATED APPLICATIONS

This application is a divisional application of U.S. patent application Ser. No. 10/933,480 filed on Sep. 3, 2004, which claims priority to Japanese Patent Application No. 2003-318437 filed on Sep. 10, 2003. The entire disclosures of U.S. patent application Ser. No. 10/933,480 and Japanese Patent Application No. 2003-318437 are hereby incorporated herein by reference.

### BACKGROUND OF THE INVENTION

1. Field of the Invention

The present invention relates to a color filter substrate for use in liquid crystal devices and other such electro-optical apparatuses, and to a method of manufacturing such color filter substrate. The present invention also relates to an electro-optical device having such color filter substrate. The present invention further relates to electronic equipments such as a portable phone, a portable information terminal, or other electronic equipments configured to use such electro-optical device.

2. Background Information

It is common in conventional practice for color to be displayed by a liquid crystal device, an organic EL device, or other such electro-optical apparatus. A color filter substrate is incorporated into the interior of such electro-optical apparatus. This color filter substrate is formed, for example, by forming three coloring elements of R (red), G (green), and B (blue) on a base made of transparent glass so that they form a predetermined pattern.

There are three known types of liquid crystal devices. The first is so-called a reflective type liquid crystal device in which external light such as the sun light or room light is reflected internally within the device such that the reflected light is displayed. The second is so-called a transmissive type liquid crystal device in which the light is emitted by a cold cathode tube, LED (light emitting diode) or other light source and passes through inside the liquid crystal device. The third is a semi-transmissive-reflective type liquid crystal device that has functions of both of the reflective and transmissive type liquid crystal devices.

In both the reflective and semi-transmissive-reflective type liquid crystal devices, when the display uses reflected light to display image, the external light passes through coloring elements of the color filter twice, which increases color absorption and reduces the display brightness. To solve this problem, reflective type liquid crystal devices that have within the pixel area an uncolored region, in other words an exposed reflective film, have been conceived. Japanese Patent Application Publication 10-186347 in FIG. 1 and on pages 3-4 shows such reflective type liquid crystal device. In this liquid crystal device, the passage of bright light through the exposed region of the reflective film prevents the reduction in brightness of the color display.

Also, it has been known to align a light passage opening in the light reflective film against the portion of the coloring element having the maximum thickness in a conventional semi-transmissive-reflective liquid crystal device, the film thickness of the coloring element is increased in a region of the coloring element that corresponds to the transmissive portion. See page 7 and FIG. 5 of Japanese Patent Application 2002-287131. This technique enables a uniform color display in the reflective and transmissive display modes by bringing the light paths in the reflective portion and the transmissive portion substantially equal to one another.

In the liquid crystal device disclosed in Japanese Patent Application Publication 10-186347, since an exposed reflective film is placed inside the black mask, in other words since the exposed reflective film is placed in a region that is separate from the black mask, the available areas for the coloring elements are reduced, accordingly the color saturation is compromised. In the liquid crystal device of Japanese Patent Application 2002-287131, it was difficult to adequately differentiate the thickness of the thickness of coloring element in the transmissive portion and in the reflective portion. If the thickness of the coloring element film is reduced, the color saturation would be insufficient. If the thickness of the coloring element film is increased for higher color saturation, the brightness would be insufficient.

Also, when photolithography is used to set the film thickness of the coloring element, photolithography must be repeated separately on the reflective and transmissive portions, at an excessive cost and time.

In view of the above, it will be apparent to those skilled in the art from this disclosure that there exists a need for an improved color filter substrate and method of manufacturing such color filter substrate that overcome the problems of the prior arts. This invention addresses this need in the art as well as other needs, which will become apparent to those skilled in the art from this disclosure.

### SUMMARY OF THE INVENTION

An object of the present invention is to provide a color filter substrate that is capable of adequately adjusting the film thickness of the coloring element in both the reflective portion and the transmissive portion. More specifically, the color filter substrate of the present invention is capable of providing a color display that is bright in the reflective portion and that has sufficient color saturation in the transmissive portion. It is also an object of the present invention to provide a method of manufacturing such color filter substrates; electro-optical apparatus having such color filter substrate; and electronic equipment having such electro-optical apparatus.

A color filter substrate of the present invention has a transmissive portion through which light rays are transmitted and a reflective portion on which light rays are reflected, the color filter substrate. The color filter substrate includes a transmissive base; a foundation layer formed over the transmissive base and having a depressed portion formed at the transmissive portion; a reflective film formed over the foundation layer; a bank formed over the reflective film so as to define a deposit region; and a coloring element disposed within the deposit region that is defined by the bank. The thickness of the coloring element is greater at the transmissive portion than at the reflective portion.

In a manufacturing method for a color filter substrate of the present invention, the color filter substrate has a transmissive portion through which light rays are transmitted and a reflective portion on which light rays are reflected. The method includes providing a transmissive base; forming a foundation layer over the transmissive base such that a depressed portion is formed at the transmissive portion; forming a reflective film over the foundation layer so as to have an opening at the transmissive portion; forming banks over the reflective film so as to define a deposit region; and forming a coloring element over the reflective film with droplet discharge onto the deposit region defined by the bank.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a plan view showing one pixel portion of one embodiment of the color filter substrate in accordance with an embodiment of the present invention;

FIG. 2(a) is a cross sectional view of the color filter substrate in accordance with the embodiment of the present invention viewed along line IIa-IIa of FIG. 1;

FIG. 2(b) is a cross sectional view of a color filter substrate during the process of manufacturing the color filter substrate shown in FIG. 2(a);

FIG. 3(a) is a plan view of one pixel portion on the element side substrate that is included in a liquid crystal device, which is used as an example of electro-optical apparatus in accordance with an embodiment of the present invention;

FIG. 3(b) is a cross sectional view of the element side substrate in accordance with the embodiment of the present invention viewed along line IIIb-IIIb in FIG. 3(a);

FIG. 4 is an oblique view of the liquid crystal display device, which is used as an embodiment of electro-optical apparatus in accordance with the embodiment of the present invention;

FIG. 5 is a magnified cross sectional view of one display dot region in the liquid crystal device of FIG. 4 in accordance with the embodiment of the present invention;

FIG. 6 is an oblique view of one of the switching elements used in the liquid crystal apparatus of FIG. 4;

FIGS. 7 are schematic views of different patterns of coloring members R, G and B that are arranged over the color filter substrate of FIG. 1, namely: (a) stripe pattern, (b) mosaic pattern, and (c) delta pattern;

FIG. 8 is a process flow chart showing method of manufacturing the color filter substrates in accordance with an embodiment of the present invention;

FIG. 9 is an oblique view of an inkjet head used in the manufacturing method shown in FIG. 8;

FIG. 10 is a partial oblique view of the internal construction of the inkjet head of FIG. 9;

FIG. 11 is a cross sectional view of the ink jet head viewed along line XI-XI in FIG. 10;

FIG. 12 is a block diagram of an electronic equipment in accordance with an embodiment of the present invention;

FIG. 13 is an oblique view of a portable telephone set, which is an example of electronic equipment in accordance with an embodiment of the present invention; and

FIG. 14 is an oblique view of a digital camera, which is an embodiment of electronic equipment related to the invention.

### DETAILED DESCRIPTION OF THE PREFERRED EMBODIMENTS

A color filter substrate of the present invention has a transmissive portion through which light rays are transmitted and a reflective portion on which light rays are reflected, the color filter substrate. The color filter substrate includes a transmissive base; a foundation layer formed over the transmissive base and having a depressed portion formed at the transmissive portion; a reflective film formed over the foundation layer; a bank formed over the reflective film so as to define a deposit region; and a coloring element disposed within the deposit region that is defined by the bank. The thickness of the coloring element is greater at the transmissive portion than at the reflective portion.

In a color filter substrate of the present invention, a depressed portion is formed in the foundation layer, which is underneath the coloring element, at the transmissive portion. Therefore, it is possible to increase the film thickness of the coloring element at the transmissive portion. Consequently, the film thicknesses of the coloring element can be adequately set at the reflective portion and at the transmissive portion, such that bright light rays can be obtained from the reflective portion, and well saturated light rays can be obtained from the transmissive portion.

In a color filter substrate of the present invention, it is preferable to form the coloring element from the same material at both the reflective portion and the transmissive portion. Conventionally, photolithography has been used to generally set the film thicknesses of the coloring element at the reflective portion and at the transmissive portion. However, photolithography must be repeated separately on the reflective and transmissive portions, at an excessive cost and time. By contrast, the use of the identical material for both reflective and transmissive portions simplifies the manufacturing process and reduces costs.

In a color filter substrate of the present invention, the bank preferably has an ink-repellent surface. In other words, the surface of the bank should be treated to be ink repellant, or the bank should be formed of an ink repellant material. Here, the ink to be repelled is the material for the coloring element. The ability of the bank to repel ink is very useful in preventing the material for the coloring element from being deposited thereon while the coloring element is formed with the droplet depositing technology such as inkjet technique.

Here, the ink jet technique refers to a technique whereby the material for the coloring element is jetted out of the nozzle as ink droplets and deposited at a desired location. The methods for jetting the ink include a method whereby a piezo element that vibrates on electricity varies the internal volume of the nozzle to jet out the ink; a method whereby the ink in the nozzle is thermally expanded to be jetted out; and any other desired droplet jetting methods.

In a color filter substrate of the present invention, a thickness Tt of the coloring element at the transmissive portion and a thickness Tr of the coloring element at the reflective portion preferably satisfy: 1.3≦Tt/Tr≦5. This relationship results in bright display in the reflective display mode and a well saturated and vivid display in the transmissive display mode.

In a manufacturing method for a color filter substrate of the present invention, the color filter substrate has a transmissive portion through which light rays are transmitted and a reflective portion on which light rays are reflected. The method includes providing a transmissive base; forming a foundation layer over the transmissive base such that a depressed portion is formed at the transmissive portion; forming a reflective film over the foundation layer so as to have an opening at the transmissive portion; forming banks over the reflective film so as to define a deposit region; and forming a coloring element over the reflective film with droplet discharge onto the deposit region defined by the bank.

In the manufacturing method of a color filter substrate of the present invention, a depressed portion is formed in the foundation layer at the transmissive portion; and an opening is formed in the reflective film at the transmissive portion. Accordingly, the film thickness of the coloring element at the transmissive portion can be sufficiently increased, consequently allowing the film thicknesses of the coloring element to be adequately set at the reflective portion and the transmissive portion. Therefore, a color display device having a color filter substrate that is manufactured by the foregoing method renders a bright display in the reflective display mode, and a well saturated display in the transmissive display mode.

In the manufacturing method for a color filter substrate of the present invention, it is preferable that the amount of droplets to be deposited onto the discharge region is greater at the transmissive portion than at the reflective portion during the process of forming the coloring element. The increase will result in supplying a large amount of material for the coloring element at the transmissive portion, ensuring a thicker film thickness at the transmissive portion. Specific methods by which the amount of droplets to be jetted out can be increased include, for example, increasing the amount of each droplet to be jetted out of the inkjet nozzle, and increasing the number of droplets to be deposited onto the transmissive portion.

In the manufacturing method for a color filter substrate of the present invention preferably further includes rendering a surface of the bank ink repellent. In other words, the surface of the bank should be treated to be ink repellant, or the bank should be formed with an ink repellant resin. By rendering the bank ink-repellent, it is possible to prevent color element material, which is accidentally deposited onto the bank during the droplet discharge such as ink jetting, from being attached to the bank. Accordingly, it is possible to form the coloring element in a consistent shape, and at the same time prevent mixing of colors between coloring elements.

The electro-optical apparatus of the present invention is includes the color filter substrate of the present invention, and a layer of an electro-optical material disposed over the color filter substrate. Here, examples of the electro-optical material include, for instance, liquid crystals used in a liquid crystal apparatus, an organic EL used in an organic EL apparatus, and gases for gas discharge as in plasma display apparatus. These electro-optical materials may be disposed in direct contact with the color filter substrate; sandwiched between the color filter substrate and an opposite substrate; or in any other manner as may be suitable for the construction of electro-optical apparatus. Examples of such electro-optical apparatus may include liquid crystal apparatuses, organic EL apparatuses, plasma display apparatuses and other apparatuses.

In the electro-optical apparatus of the present invention, a depressed portion is formed on the foundation layer at the transmissive portion. Therefore, it is possible to set the film thicknesses of the coloring element adequately at the reflective portion and the transmissive portion. Consequently, a bright display can be obtained in the reflective display mode while a well saturated display can be obtained in the transmissive display mode. Therefore, various data can be displayed in vivid colors.

An electronic equipment in accordance with the present invention includes the foregoing electro-optical apparatus and controlling means for controlling the electro-optical apparatus. Examples of such electronic equipment may include, for example, portable telephone sets, portable information terminal sets, PDAs (personal digital assistants) and various other equipments.

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### FIRST EMBODIMENT

### Color Filter Substrate and Electro-Optical Apparatus

An example of the color filter substrate in accordance with the present invention and an electro-optical device in which the color filter substrate is used will now be described. In the following description, a semi-transmissive/reflective liquid crystal device, which is an active-matrix liquid crystal device that uses a TFD (thin film diode) as a two-terminal switching component, is given as an example. The present invention is of course not limited to this embodiment.

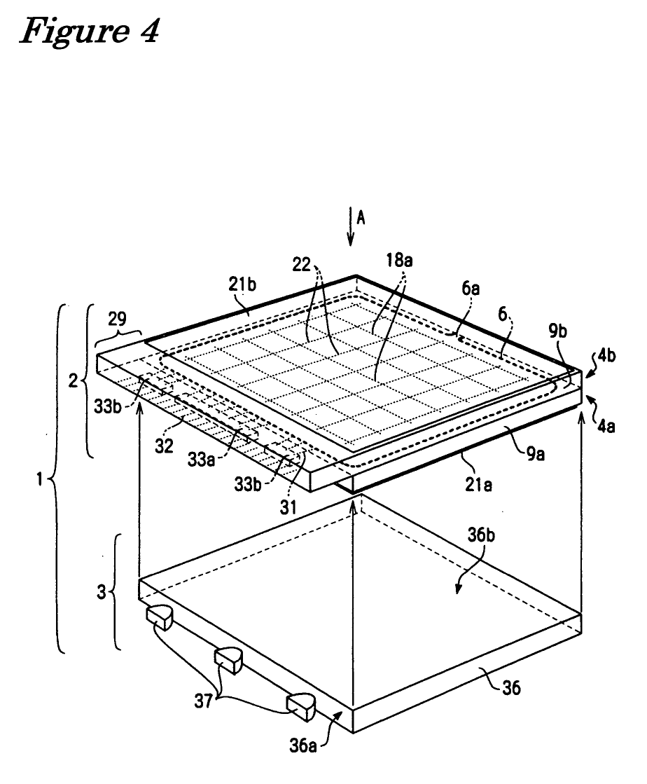

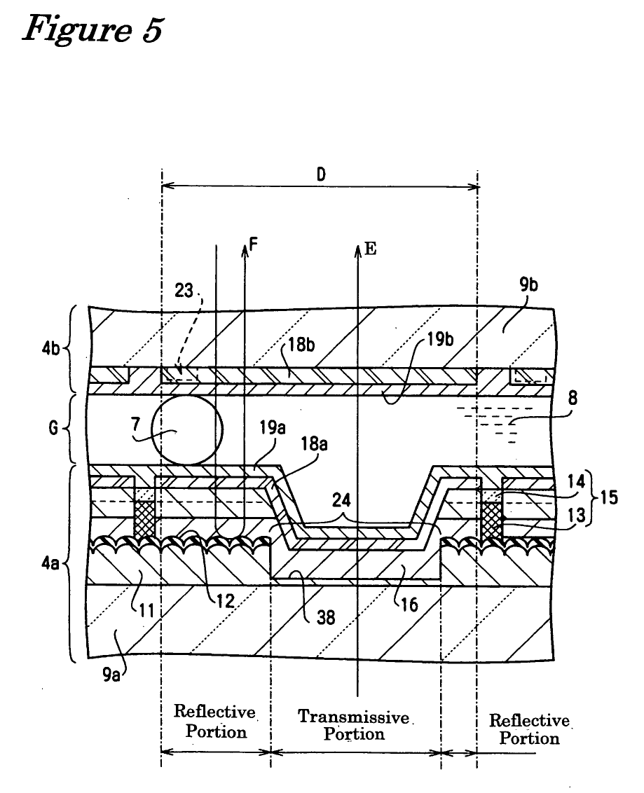

Referring to FIG. 4, a liquid crystal device 1, which is an example of an electro-optical apparatus, includes a liquid crystal panel 2 and an illuminating device 3. The liquid crystal panel 2 is formed by bonding a first substrate 4a and a second substrate 4b together with an annular sealing member 6. The first substrate 4a is a color filter substrate whereon a color filter is to be formed. The second substrate 4b is an element substrate whereon a TFD (Thin Film Detector) element is to be formed. FIG. 5 shows a magnified view of one of the display dot sections D in the liquid crystal panel 2 of FIG. 4. As shown in FIG. 5, a gap, a so-called cell gap G, is formed between the first substrate 4a and the second substrate 4b and maintained by a spacer 7. The liquid crystal fills the cell gap G to form a liquid crystal layer 8.

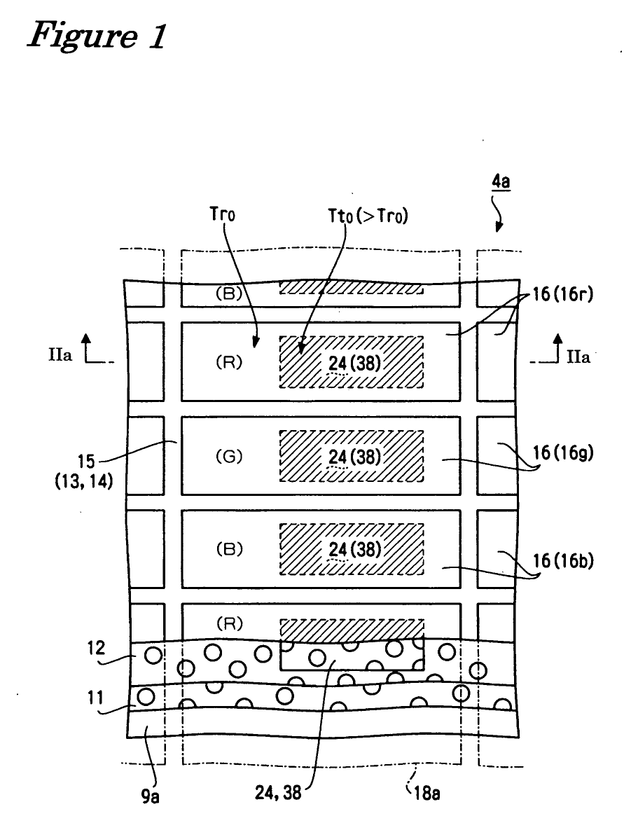

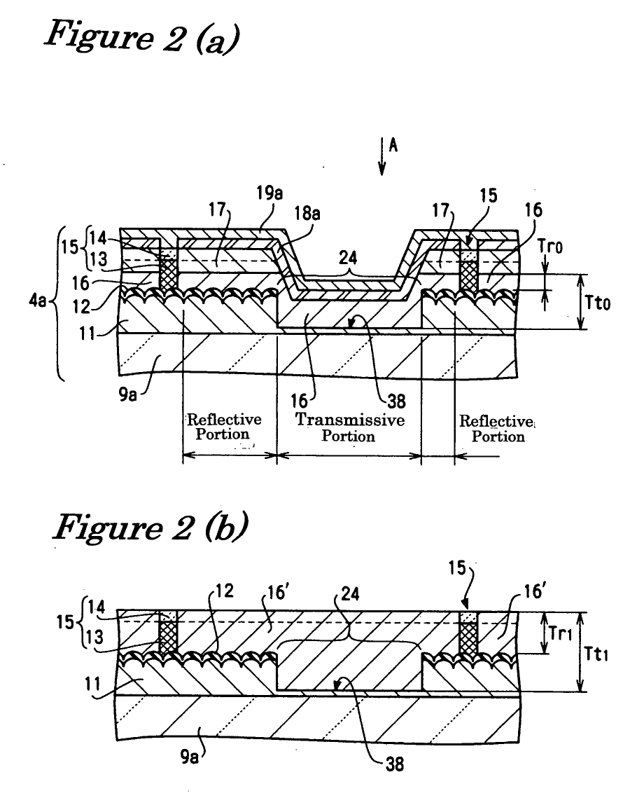

FIG. 1 shows a two-dimensional constitution of one pixel area of the first substrate 4a, as viewed from the direction of the arrow A in FIG. 4. This viewing direction is the same as the direction in which the viewer views the display. FIG. 2(a) is a cross sectional view of the first substrate 4a viewed along the line IIa-IIa shown in FIG. 1. In FIG. 2(a), the first substrate 4a includes a first base member (rear base) 9a which is made of light transmissive glass, light transmissive plastic or any other light transmissive material. A resin layer 11 is formed on the liquid crystal side of the first base member 9a, over which is formed a reflective film 12.

As seen in FIG. 2, a light blocking member 13 is formed over a reflective film 12. An ink repellant layer 14 is formed over the light blocking member 13. The light blocking member 13 and the ink repellant layer 14 form a bank 15. The ink repellant layer 14 has the ability to repel material for a coloring element that is jetted out by an inkjet technique, which will be described later. Although the ink repellent layer 14 is provided in this embodiment, if the light blocking member 13 is formed with an ink repellant resin, the ink repellant layer 14 is not required. The bank 15 frames deposit regions onto which a material for the coloring element is sprayed by the inkjet process, which will be further described later.

The bank 15 is formed in a grid-like pattern (an example of the lattice-like pattern) as shown in FIG. 1, such that its strips extend in a direction perpendicular to the paper plane of FIG. 2(a), as well as left to right direction of FIG. 2(a). A coloring element 16 is formed within each square-like region framed by the bank 15. The coloring elements 16 have three colors, namely R (red), G (green), and B (blue), one of which being formed in each region framed by the bank 15.

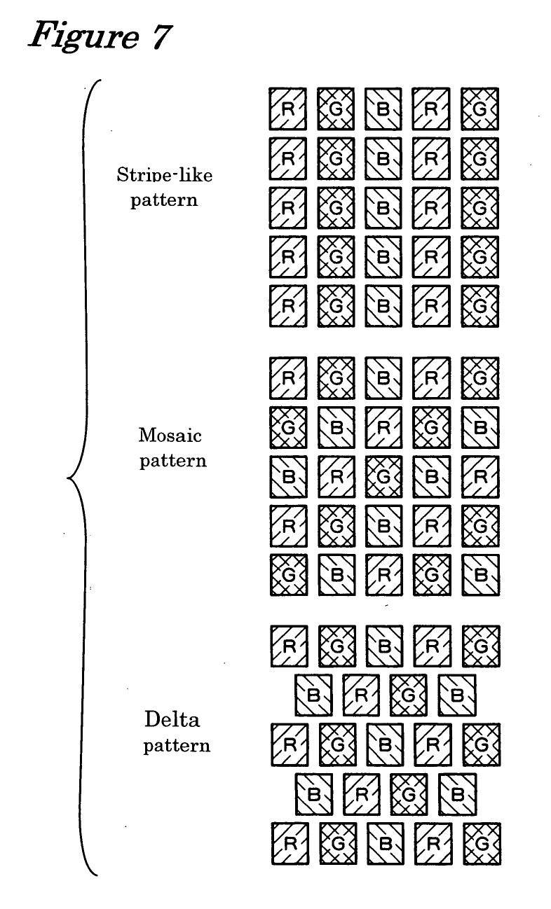

As shown in FIG. 1, coloring elements in the R, G and B colors are respectively called coloring elements 16r, 16g and 16b. In the present embodiment, the coloring elements 16 in the colors of R, G and B are arranged to form the stripe pattern as shown in FIG. 7(a).

Alternatively, the coloring elements may also be arranged in a pattern other than the stripe pattern, such as the mosaic pattern shown in FIG. 7(b) or the delta pattern shown in FIG. 7(c). The mosaic pattern is a pattern where the R, G and B colors are repeated in the same sequence in both longitudinal and lateral directions. The delta pattern is a pattern where the R G and B colors are placed at vertices of a triangle pattern and the colors are repeated in the same sequence in the lateral direction.

In FIG. 2(a), an overcoat layer 17 is formed over the coloring elements 16, strip-shaped transparent electrodes 18a are formed on the overcoat layer 17, and an orientation film 19a is formed further on the electrodes 18a. The orientation film 19a is subjected to an orientation treatment such as rubbing treatment, whereby the orientation of the liquid crystal molecules near the orientation film 19a is set. Also, a polarizing plate 21a is mounted on the outside surface of the first base member 9a by bonding or the like, as shown in FIG. 4.

In FIG. 2(a), a rugged irregular surface is formed on the resin layer 1, and also on the reflective film 12 that is formed over the resin layer 11. The pattern of the ruggedness is random when viewed in the direction of arrow A. The presence of ruggedness causes scattering of light rays that are incident on the reflective film 12. The strip-like transparent electrodes 18a extend in a direction orthogonal to the paper plane of FIG. 2(a), such that the intervals between adjacent electrodes 18a are approximately equal to the width of the light blocking member 13. The intervals render the plurality of electrodes 18a appear to be in a stripe pattern, as seen from the direction of arrow A.

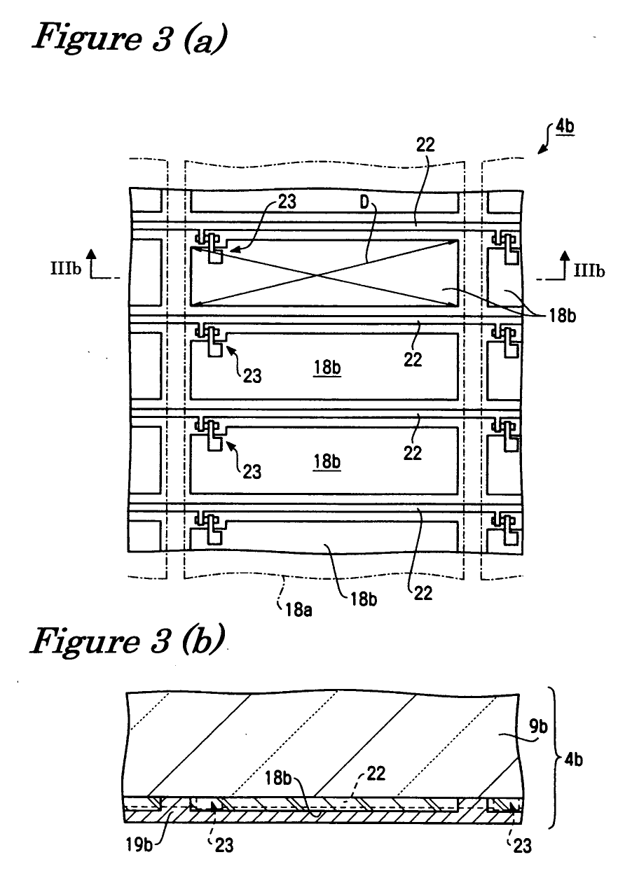

In FIG. 5, the first substrate 4a and the second substrate 4b face each other across the liquid crystal layer 8. FIG. 3(b) shows the cross sectional view of the second substrate 4b along line IIIb-IIIb shown in FIG. 3(a). In FIG. 3(b), the second substrate 4b includes a second base member (front base) 9b made of a light transmissive glass, plastic or another material. A line wiring 22 which has a linear form, TFD elements 23 which are active elements, and dot electrodes (pixel electrodes) 18b which are transparent, and orientation film 19b are all formed on a liquid crystal side surface of the second substrate 4b. The orientation film 19b is given an orientation-rendering treatment such as rubbing, for orienting the liquid crystal molecules near the orientation film 19b. The rubbing direction of the surface of the orientation film 19a that faces the first substrate 4a in FIG. 5 and that of the surface of the orientation film 19b that faces the second substrate 4b cross each other at an appropriate angle depending on the crystalline characteristics. In FIG. 4, the polarizing plate 21b is glued or otherwise attached to the outside surface of the second base member 9b.

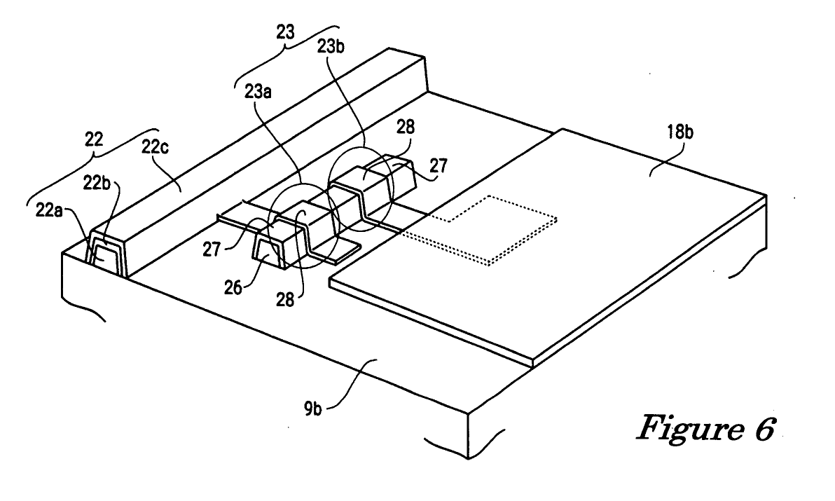

In FIG. 3(a), the dot electrode 18b is formed as a substantially square or rectangular shaped dot, and is connected to the line wiring 22 through the TFD element 23. The transparent electrode 18a, formed in a strip-like shape and disposed on the first substrate 4a side, is shown in FIG. 6(a) in broken lines for reference. The area where the dot electrode 18b and the transparent electrode 18a appear to overlap each other in a plan view constitutes one display dot region D. One display dot region D corresponds to one of the three colors, R, G and B. In the present embodiment of color display, three display dot regions D, which correspond to the three colors, R, G and B, constitute one pixel. In FIG. 5, the reflective film 12 has an opening 24 for each display dot region D for allowing light rays to pass through. The opening 24 is formed to pass light rays to the reflective film 12 in this embodiment, so as to form the transmissive portion. Portions of the color filter substrate 4a where the opening 24 is not formed in the reflective film 12 are reflective portions.

The TFD element 23 shown in FIG. 3(a) is formed by connecting a first TFD element 23 and a second TFD element 23b in series, as shown in FIG. 6. The TFD element 23 is formed, for instance, in the following manner. Firstly, a first layer 22a of the line wiring 22 and a first metal 26 of the TFD element 23 are formed with TaW (tantalum tungsten). Secondly, a second layer 22b of the line wiring 22 and an insulation film 27 of the TFD element 23 are formed by an anodizing process. Thirdly, a third layer 22c of the line wiring 22 and a second metal 28 of the TFD element 23 are formed with Cr (chrome), for example.

The second metal 28 of the first TFD member 23a extends out of the third layer 22c of the line wiring 22. The dot electrode 18b is formed so as to overlap with the tip of the second metal 28 of the second TFD member 23b. If an electric signal is to flow from the line wiring 22 in the direction toward the dot electrode 18b, the electric signal would flow through the first TFD member 23a, from the second metal 28 to the insulation film 27 and thence to the first metal 26. On the other hand, in the second TFD member 23b, the electric signal would flow from the first metal 26 to the insulation film 27, then to the second metal 28.

In other words, a pair of electrically opposed TFD members are connected in series between the first TFD member 23a and the second TFD member 23b. It is known that a TFD element in such a construction, commonly called a back-to-back construction, offers more stable characteristics than a TFD element constituted with only one TFD member.

In FIG. 4, the second substrate 4b includes an overhang portion 29 that projects beyond the first substrate 4a. A wiring 31 and a terminal 32 are formed on a surface of the overhang portion 29 that faces the first substrate 4a. One driver IC 33a and two driver ICs 33b are installed through an ACF (anisotropic conductive film), which is not illustrated, in a region where the wiring 31 and the terminals 32 are gathered.

The wiring 31 and the terminals 32 are formed on the second substrate 4b concurrently when the line wiring 22 and the dot electrodes 18b are formed. The line wiring 22 extends onto the overhang portion 29, becomes a wiring 31 thereon, and becomes connected to the driver IC 33a. There are spherical or cylindrical conducting members (not illustrated in Figures) that are mixed into the sealing member 6, which glues the first substrate 4a and the second substrate 4b together. The transparent electrodes 18a, which are formed over the first substrate 4a, extend over the first substrate 4a up to the location of the sealing member 6, and thereupon are connected through the conductive members to the wiring 31 on the second substrate 4b. The transparent electrodes 18a, which are on the first substrate 4a, are thus connected to the driver IC 33b, which is on the second substrate 4b.

In FIG. 4, an illumination device 3 is disposed facing the outside surface of the first substrate 4a, which is a component of the liquid crystal panel 2. The illumination device 3 includes a light guide 36, which is a square plate and is made of transparent plastic, for example; and LEDs 37, which are point sources of light. A light reflective sheet (not illustrated in the Figures) may be additionally installed on the surface of light guide 36, which is facing the liquid crystal panel 2. A light diffusing sheet (not illustrated in the Figures) may also be installed on the surface of the light guide 36, which is facing the liquid crystal panel 2. Additionally, a prism sheet (not illustrated in the Figures) may also be installed over the light diffusing sheet. Although three LEDs 37 are used in the present embodiment, only one, two or more than three LEDs 37 may also be used. A line light source such as a cold cathode tube, or other point light sources can also be used in lieu of the LED.

An explanation follows with regard to a liquid crystal device constituted as described in the foregoing.

If external light of sufficient brightness is available, external light such as sunlight or room light is taken inside the liquid crystal panel 2 through the second substrate 4b, as shown by an arrow F in FIG. 5. This external light F, after passing through the liquid crystal layer 8, is reflected by the reflective film 12 and supplied to the liquid crystal layer 8. If, on the other hand, the external light is insufficient, the LEDs 37 of the illuminating device 3 shown in FIG. 4 are lit. Here, the light from the LEDs 37, which are a point-source light, is directed inside the light guide 36 through a light entrance surface 36a of the light guide 36, and thereafter emitted as a surface light from the surface that faces the liquid crystal panel 2, which is a light emitting surface 36b. As shown by an arrow E in FIG. 5, light from the entire light emitting surface 36b is supplied, now as a surface-source light as opposed to point-source light, to the liquid crystal layer 8, through the openings 24, which are formed in the light reflective film 12.

While light is being supplied to the liquid crystal 8 in the foregoing manner, the driver ICs 33a and 33b in FIG. 4 control the liquid crystal panel 2. A scanning signal, for instance, is supplied to the line wiring 22 while a data signal, for instance, is supplied to the transparent electrode 18a concurrently. Here, if the TFD element 23 (see FIG. 3(a)) associated with a particular display dot assumes the selected status (that is, the “on” state) in response to a voltage differential between the scanning signal and the data signal, an image signal is written to the liquid crystal capacitance within that display dot. Thereafter, if the particular TFD element 23 assumes the unselected status (that is, the “off” state), that image signal is stored in the display dot and drives the liquid crystal 308 within the display dot.

As seen, the liquid crystal molecules of the liquid crystal layer 8 are controlled for each display dot. That is, light passing through liquid crystal layer 8 of each display dot D is modulated. As the light so modulated passes through polarizing plate 21b which is located on the second substrate 4 side in FIG. 4, characters, numbers, patterns and other images are displayed in the effective display region of the liquid crystal panel 2. A display that uses the external light reflected off the reflective film 12 shown in FIG. 5 is the display in the reflective display mode. A display that uses the light from the illuminating device 3 is the display in the transmissive display mode. In the present embodiment, the reflective display mode and the transmissive display mode may be used as desired by the user or as automatically selected to suit the ambient environment.

In FIG. 5, as has been explained, the transmissive portion and the reflective portion are formed in each display dot D. Likewise, as has also been explained, the transmissive portion is formed by providing the opening 24 in the reflective film 12. In the present embodiment, as seen in FIG. 2, a depression, which is a depressed portion 38, is formed in the resin layer 11, which is a foundation layer, opposite the transmissive portion. The shape of the depressed portion 38 as viewed from the direction of arrow A in FIG. 2 is the same, or approximately the same as that of the opening 24 formed in a reflective film 12. Instead of forming the depressed portion 38 on the resin layer 11, a through hole that reaches down to the first base member 9a may be substituted for the depressed portion 38.

Due to the depressed portion 38 that is formed in the transmissive portion, the film thickness Tt0 of the coloring element 16 at the transmissive portion is greater than the film thickness Tr0 of the coloring element 16 at the reflective portion. By providing the coloring element 16 so as to have a greater film thickness Tr0 at the reflective portion than the film thickness Tr0 at the transmissive portion, the length of the path through the coloring element 16 that the light ray F passes in the reflective display mode becomes short, as seen in FIG. 5. Accordingly, it is possible to provide a bright color display when in the reflective display mode. On the other hand, the length of the path through the coloring element 16 that the light ray E takes in the transmissive display mode becomes long. Therefore, it is possible to provide a color display with high color saturation when in the transmissive display mode.

Furthermore, it may be possible to obtain a bright color display in the reflective display mode and a well saturated color display in the transmissive display mode as described above without having to vary the film thickness of the coloring element 16 in the transmissive portion and in the reflective portion, if different materials are used for the coloring element 16 in the transmissive and reflective portions. However, the use of different materials for the coloring element 16 would render the formation process of the coloring element very difficult. By contrast, by using the same material for the coloring element 16 in both transmissive portion and reflective portion, it is possible to form the coloring elements 16 in a very simple manner.

### Modification of Color Substrate 4A

In the foregoing embodiment, the present invention was applied to semi-transmissive-reflective liquid crystal devices of active matrix type using TFD elements, which are 2-terminal type switching elements. The present invention is, however, also applicable to liquid crystal devices of active matrix type using TFT (thin film transistor), which are 3-terminal type switching elements. The present invention is likewise applicable to simple matrix type liquid crystal devices that use no switching elements. The present invention is further applicable to reflective type liquid crystal devices. The present invention is still further applicable to non-liquid crystal type electro-optical devices such as organic EL devices, plasma display devices, and many others.

### Method of Manufacturing Color Filter Substrate 4A

The method for manufacturing a color filter substrate in accordance with the present invention will now be described using a case of manufacturing the color filter substrate 4a shown in FIGS. 1 and 2 as an example.

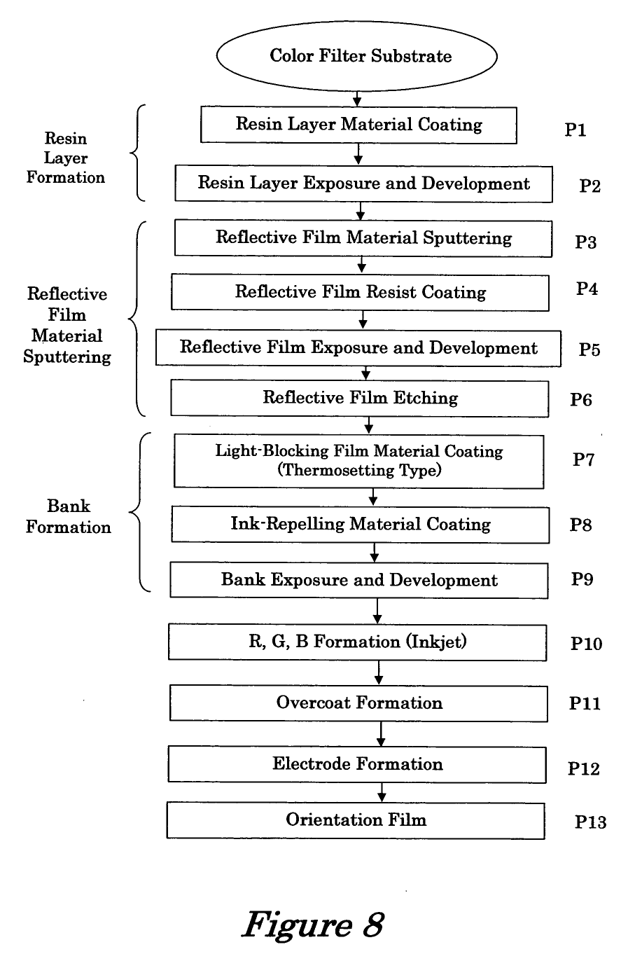

FIG. 8 shows a method of manufacturing a color filter substrate according to one embodiment of the present invention. In process P1, the material for the resin layer 11 shown in FIG. 2, which is a photosensitive resin in the present embodiment, is evenly applied over the first base member 9a. Next, in process P2, the layer of the resin layer material is exposed and developed to form the resin layer 11. Concurrently, a randomly rugged pattern is formed over the surface of resin layer 11. Also concurrently, the depressed portion 38 is formed opposite the transmissive portion. In this manner, the resin layer 11 having a random irregular surface and the depressed portion 39 at each of the display dots D is formed on the first base member 9a.

Next, in process P3, the material for the reflective layer 12 shown in FIG. 2, for example Cr, is applied over the resin layer 11 evenly by a sputtering process. In process P4, a resist material is applied evenly over the material layer of the reflective film 12 which has just been formed, and the layer of the resist material is exposed and developed to form a resist film of a desired pattern.

In process P5 that follows, the material layer for the reflective film 12 is exposed to light and developed, while the foregoing resultant resist film functions as a mask. In process P6, the surface is etched to form the reflective layer 12 over the resin layer 11. An opening 24 is also formed in this process in each of the display dot D. In this manner, the reflective film 12 is now formed with the opening 24 disposed in each display dot D.

In process P7, the reflective film 12 is coated evenly with a material for the light blocking member 13 such as photosensitive resin in black or other colors. In process P8, a photosensitive and ink repellant material is applied evenly over the material layer of the light blocking member 13. The process results in double coatings of the ink repellant material and the material for the light blocking member 13. In process P9, the double-coated layer in the foregoing is exposed to light and developed to form the banks 15, which are in grid-shape as shown in FIG. 1. The light blocking member 13 used in the present embodiment has no ink repellant property by itself. Therefore, an ink repellant layer 14 is formed over light blocking member 13. If the light blocking member 13 is hypothetically produced with an ink repellant material, the ink repellant layer 14 would be unnecessary, and the bank 15 could be produced solely with such light blocking member.

The bank 15 functions as a partitioning structure that defines deposit regions in the droplet jet paining process with inkjet technique, which will be further explained later. The bank 15 also functions as a black mask in the color display. The ink repellant layer 14 is a member used to repel the material for the coloring element 16 that is jetted out in droplets, and is preferably formed with, for example, a fluorine type material. The foregoing process of forming the bank 15 results in formation of a plurality of rectangular deposit regions that is framed by the banks 15 and arranged in a dot matrix, as shown in FIG. 1.

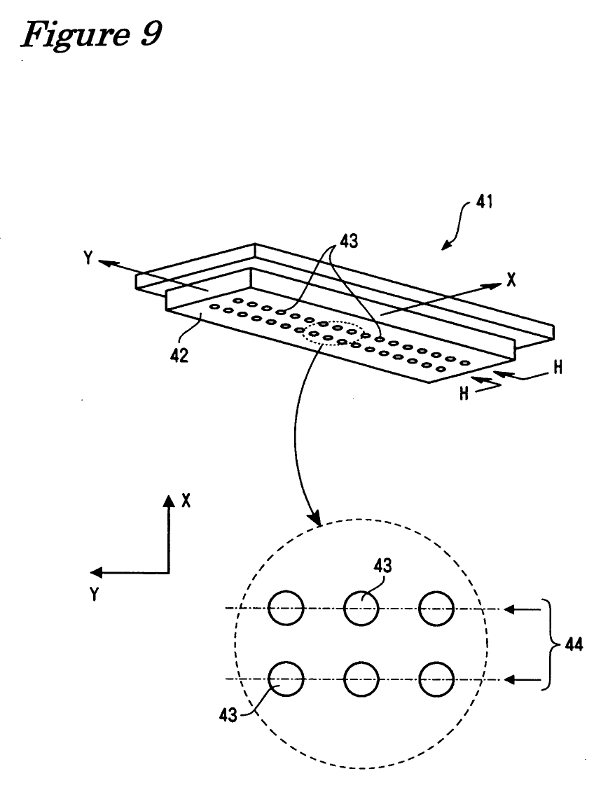

Then, in the subsequent process P10 shown in FIG. 8, the material for the coloring elements 16 is disposed by droplet discharge or ink jetting, in the dot regions that are framed by the bank 15. The reflective film 12 is formed in accordance with an inkjet technology by scanning/moving the inkjet head 41 shown in FIG. 9 in a planar fashion as shown by arrows X and Y, for example. The inkjet head 41 has a substantially rectangular casing 42, and a plurality of nozzles 43 is provided to the bottom of the casing 42. The nozzles 43 have a small opening with a diameter of about 0.02 to 0.1 mm.

In the present embodiment, the plurality of nozzles 43 is provided in two rows, and two nozzle rows 44, 44 are formed in the head 41. In each nozzle row 44, the nozzles 43 are provided in a straight line at predetermined intervals. Liquid material is supplied to these nozzle rows 44 from directions shown by arrows H. The liquid material thus supplied is discharged as tiny droplets from the nozzles 43 in accordance with the vibration of the piezoelectric element 58. Although there are two nozzle rows 44 in this embodiment, the number of nozzle rows 44 may also be one or three or more. If there are more than three nozzle rows 44, materials for the coloring elements 16 of different colors R, G, B can be assigned to different nozzle rows 44, such that the nozzle rows 44 of one ink jet head 41 can deposit the materials for the coloring elements 16 of all colors.

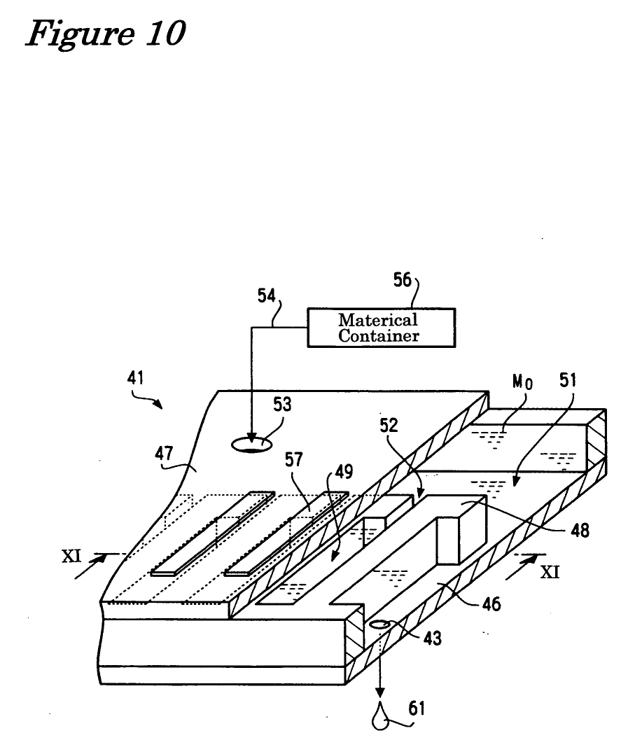

The inkjet head 41 has, for example, a stainless nozzle plate 46, a vibrating plate 47 disposed facing the nozzle plate 46, and a plurality of partitioning members 48 for bonding together the nozzle plate 46 and the vibrating plate 47, as shown in FIG. 10. Also, a plurality of storage chambers 49 for storing the liquid material, and a liquid collector 51 disposed at a location in which the liquid material temporarily collects, are defined by the partitioning members 48 between the nozzle plate 46 and the vibrating plate 47. Furthermore, each of the plurality of storage chambers 49 and the liquid collector 51 are communicated via a channel 52. Also, a feed port 53 for the liquid material is formed at an appropriate location in the vibrating plate 47, and a material container 56 is connected to the feed port 53 via a tube 54. Material for a reflective film is stored in the container 56, and liquid material M0 supplied from the container 56 is filled into the liquid collector 51 and then filled into the storage chambers 49 via the channel 52.

The nozzle plate 46, which is a part of the inkjet head 41, is provided with nozzles 43 for spraying liquid material in jet style from the storage chambers 49. A plurality of these nozzles 43 is aligned to constitute nozzle rows 44 as previously described with respect to FIG. 9.

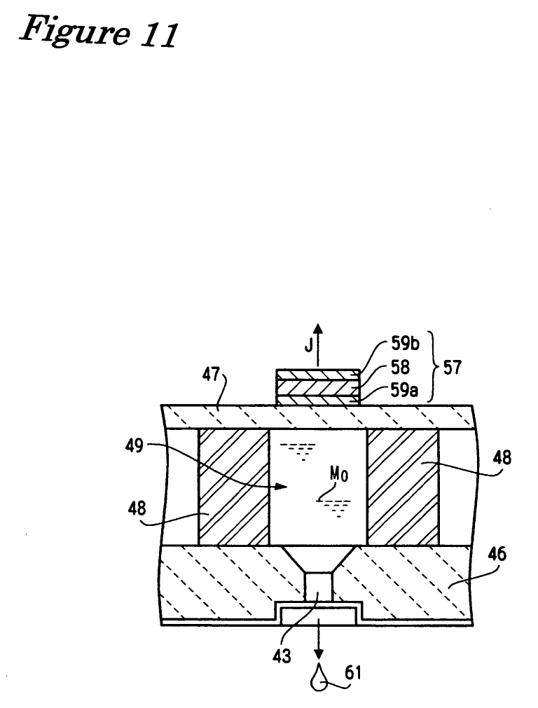

Also, the vibrating plate 47 is provided with a pressure element 57 so as to correspond to the storage chambers 49 for applying pressure to the liquid material. This pressure element 57 has a piezoelectric element 58 and a pair of electrodes 59a and 59b on both sides of the piezoelectric element 58, as shown in FIG. 11.

Upon passing the electricity between the electrodes 59a and 59b, the piezoelement 58 distortedly deforms to project outward in the direction of arrow J, thereby increasing the volume of the storage chamber 49. Accordingly, the liquid material M0 flows from the liquid reservoir 51 to the storage chamber 49 via the passage 52 by a volume equivalent to the increase in the volume of the storage chamber 49.

When the passing of the electricity to the piezoelement 58 is stopped, the piezoelement 58 and the vibrating plate 47 return to the original state, and the volume of the storage chamber 49 also returns to the original volume. As a result, the pressure on the liquid material within the storage chamber 49 increases, jetting the liquid material out of the nozzle 43 as droplets 61. The droplets 61 are jetted out stably as minute droplets regardless of the kind of solvent or other ingredients that might be included in the liquid material.

In this case, dedicated inkjet heads 41 are provided for each of the coloring elements 16 of the three colors R, G, and B; and the heads 41 are installed in different stages in the production line. Coloring elements 16 of each color are then separately formed with the inkjet heads 41 for each color. Depending on the situation, it is also possible to incorporate a supply system for coloring element material of all three colors into one inkjet head 41, and to discharge the coloring elements 16 of the three colors solely with the single inkjet head 41.

By forming the coloring elements 16 with the ink jetting technology that uses the aforementioned inkjet head system, it is possible to reduce the consumption of coloring element material greatly, as compared to a case where the coloring elements are formed with a conventional patterning technology that uses photolithography. The production process is also significantly simplified.

In the inkjet process of the present embodiment, a material 16′ of the coloring element 16 is jet sprayed to obtain the film thickness Tt1 in the transmissive portion and the film thickness Tr1 in the reflective portion as shown in FIG. 2(b). That is, a greater amount of material is sprayed in the transmissive portion than in the reflective portion. In order to spray a greater amount of material 16′ onto the transmissive portion than onto the reflective portion, it is desirable to increase the size of one droplet or increase the number of droplets to be deposited onto the transmissive portion during the droplet depositing by the inkjet head 41 shown in FIG. 9.

After depositing the material 16′ for the coloring element 16 onto the second base member 9b as shown in FIG. 2(b), a baking, that is, the drying of the material 16′ for the coloring element 16 is performed. In this manner, a film of the coloring element 16 having a thickness of Tt0 at the transmissive portion and a thickness of Tr0 at the reflective portion is formed, as shown in FIG. 2(b). The thicknesses are set so as to be Tt0>Tr0, in the end. Such baking process may be performed, for example, by placing the substrate member 4a on a hot plate that heats up to a prescribed temperature.

After the coloring elements 16 are formed by ink jetting, an overcoat layer 17 as shown in FIG. 2(a) is formed in the subsequent step P11 shown in FIG. 8. Furthermore, strip-shaped electrodes 18a are formed in step P12 as shown in FIG. 2(a) by photolithography and etching, from ITO (indium tin oxide) or another such transparent conductive material. Furthermore, an orientation film 19a is formed in step P13 from polyimide or the like. A color filter substrate 4a is thereby manufactured as described above.

According to the method of manufacturing the color filter substrate of the present embodiment, the use of inkjet head technique enables the manufacture of the color filter substrate shown in FIG. 1 and FIG. 2(a), significantly simply and economically. Also, by using the manufacturing method of the present embodiment, the depressed portion 38 as shown in FIG. 2(a), is formed on the resin layer 11, causing the film thickness Tt0 of the coloring element 16 at the transmissive portion to be greater than the film thickness Tr0 of the coloring element 16 at the reflective portion. The grater film thickness Tt0 of the coloring element 16 at the transmissive portion, as compared with the film thickness Tr0 of the coloring element 16 at the reflective portion, shortens the path through the coloring element 16 through which reflected light rays F pass when in the reflected display mode as shown in FIG. 5, and consequently renders the reflective display brighter. By contrast, the path through the coloring element 16 through which the transmitted light ray E passes when in the transmissive display mode becomes longer, resulting in a transmissive display that has well saturated colors.

### Modification of Method of Manufacturing Color Filter Substrate 4A

In the present embodiment, the invention was applied to manufacturing methods of a semi-transmissive-reflective liquid crystal displaying device of active matrix type that uses TFD elements, which are 2-terminal type switching elements. The invention, however, is also applicable to manufacturing methods of a liquid crystal displaying device of active matrix type that uses TFT elements (thin film transistor), which are 3-terminal type switching elements. The invention is likewise applicable to manufacturing methods of a simple matrix type liquid crystal device that uses no switching elements. The invention is also applicable to manufacturing methods of a reflective type liquid crystal device. The invention is further applicable to manufacturing methods of a non-liquid crystal type electro-optical apparatus such as organic EL apparatus, plasma display apparatus, electron emission elements (such as Field Emission Display and Surface Conduction Electron emitter Display), and many others.

### Electronic Equipments

An explanation of an electronic instrument in accordance with a fifth embodiment of the present invention will follow. This embodiment shows only an example of this invention. Therefore, the scope of the present invention is not limited to this particular embodiment.

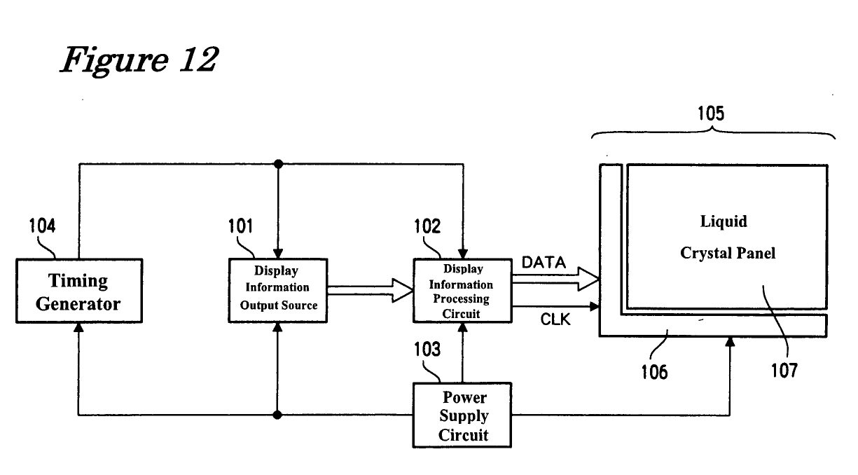

FIG. 12 shows an electronic equipment in accordance with an embodiment of the present invention. The electronic equipment includes a display information generator 101, a display information processing circuitry 102, a power supply circuitry 103, a timing generator 104 and a liquid crystal device 105. The liquid crystal device 105 further includes a liquid crystal panel 107 and a driver circuitry 106.

The display information generator 101 includes a memory such as a RAM (random access memory), a storage unit such as various discs, and a synchronizing circuitry for synchronizing digital image signals and others. The display information generator 101 supplies display information such as image signals to the display information processing circuitry 101 in a prescribed format, in accordance with various clock signals that are generated by the timing generator 104.

Next, the display information processing circuitry 102 includes various known circuitries such as amplifying and inverting circuitries, rotation circuitries, gamma correction circuitries, and clamping circuitries. The display information processing circuitry 102 processes display information that has been received, and supplies image signals together with a clock signal CLK to the driver circuitry 106. Here, a scanning line driver circuitry (not illustrated), a data line driver circuitry (not illustrated), an inspection circuitry and various other circuitries are collectively referred to as the driver circuitry 106. The power supply circuitry 103 supplies prescribed power voltages to all foregoing components. The liquid crystal device 105 may be, for instance, constituted in the same manner as the liquid crystal device 1 shown in FIG. 4.

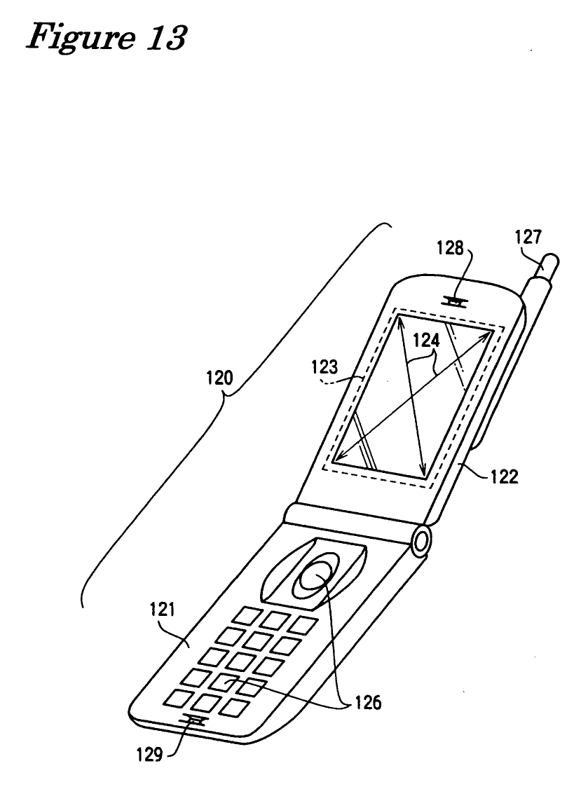

FIG. 13 shows a portable telephone set as an example of an electronic equipment in accordance with the embodiment of the present invention. A portable telephone set 120, as shown, includes a main body 121 and a display unit 122. A display device 123 having a liquid crystal device or other electro-optical device in accordance with embodiments described above is disposed within the display unit 122, such that the display unit 122 can display various displays relating to telephone communications at the display screen 124.

An antenna 127 is retractably attached to one end of the display unit 122. A loudspeaker is disposed inside a voice receiver section 128, and a microphone is installed inside a voice transmitter section 129. The control section that controls the operation of the display device 123 is disposed within a main unit 121 or the display unit 122 either integrally with or separately from a control section that controls the entire portable telephone set 120.

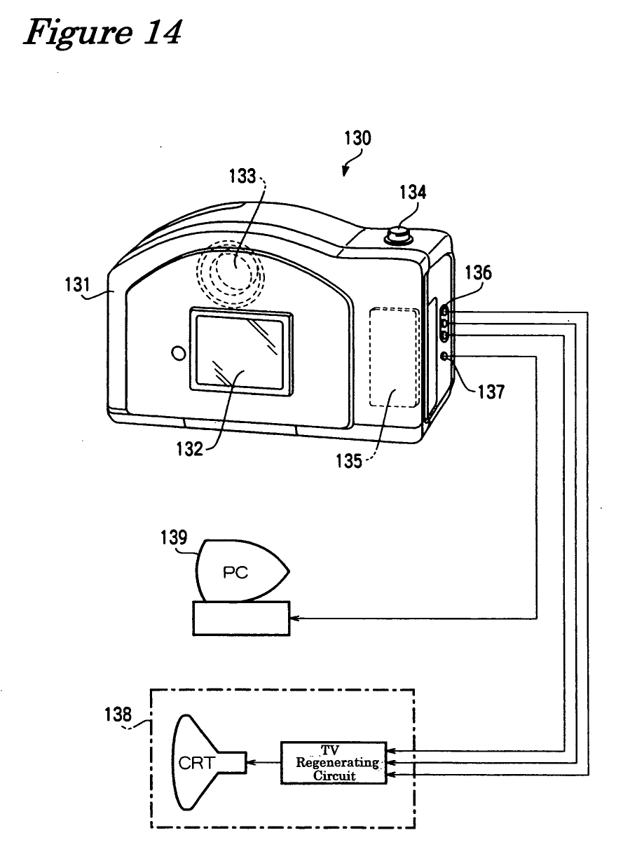

FIG. 14 shows a digital camera as another example of the electronic equipment in accordance with the present embodiment of the present invention. The digital camera has a liquid crystal device as a viewfinder. A liquid crystal display unit 132 is disposed on a surface of a case 131. Here, the liquid crystal display unit 132 functions as a viewfinder that displays the object to be photographed. The liquid crystal display unit 132 may be, for instance, a liquid crystal device 1 shown in FIG. 4.

The digital camera 130 further includes, on the front side (the back side of the drawing) of the case 131, a light receiving unit 133 having optical lenses and CCD (Charge Coupled Device). When a photographer, having verified an image of the object displayed on the liquid crystal display 132 unit, presses a shutter button 134, the CCD image signal of the particular instant is transferred to and stored in a memory on a circuit substrate 135.

A video signal output terminal 136 and a data communications input-output terminal 137 are disposed on a side surface of the case 131. A television monitor 138 is adapted to be connected to the video signal output terminal 136 as necessary. A personal computer 139 is also adapted to be connected to the data communications input-output terminal 137 as necessary. The image signal stored in a memory on the circuit substrate 135 is sent out to the television monitor 138 or the personal computer 139 through prescribed operations.

In the liquid crystal device used in each of the foregoing electronic equipments, a depression, which is the depressed portion 38, is formed in the resin layer 11, which is the foundation layer. The depressed portion 38, which is formed in the transmissive portion, causes the film thickness Tt0 of the coloring element 16 at the transmissive portion to be greater than the film thickness Tr0 of the coloring element 16 at the reflective portion. Since the film thickness Tt0 of the coloring element 16 at the transmissive portion is greater than the film thickness Tr0 of the coloring element 16 at the reflective portion, the light path through the coloring element 16, through which the reflected light ray F passes when in the reflective display mode, becomes shorter as shown in FIG. 5, resulting in a brighter reflective display. By contract, the light path through the coloring element 16, through which the transmissive light E passes when in the transmissive display mode, becomes longer, resulting in a transmissive display with an adequate color saturation.

### Modification of Electronic Equipment

In addition to a telephone set and digital camera explained in the foregoing, the present invention is applicable to other electronic equpments such as personal computers, wristwatch type electronic instruments, PDAs (personal digital assistants), liquid crystal television sets, viewfinder type or direct-view monitor type video tape recorders, automobile navigation devices, pagers, electronic notebooks, portable calculators, word processing devices, workstations, television telephone sets, and POS terminal equipments.

### OTHER EMBODIMENTS

The present invention was described above with reference to preferred embodiments, but the present invention is not limited to these embodiments, and various improvements can be made within the scope of the present invention as described in the claims.

(A) The inventors of the present invention have manufactured a plurality of liquid crystal devices that has different transmissive film thicknesses Tt0 and reflective film thicknesses Tr0, and observed color displays of each of the liquid crystal devices. As a result of the observation, the reflective display using the reflective portion and the transmissive display using the transmissive portion became most uniform, in other words, light rays from the reflective portion were brightest and light rays from the transmissive portion were best saturated, when the thicknesses Tt0 and Tr0 satisfied the following conditions:
1.3≦Tt/Tr≦5.

In other words, it is most desirable to set the film thickness Tt0 of the coloring element 16 in the transmissive portion within the range of 1.3 to 5 times relative to the film thickness Tr0 of the coloring element 16 in the reflective portion.

(B) The inventors of the present invention have also manufactured a plurality of liquid crystal devices that has different thicknesses of the coloring element, and selected those that had a uniform display in the reflected display mode and the transmissive display mode, in other words, those in which light rays from the reflective portion were brightest and light rays from the transmissive portion were most saturated. Then, the inventors have confirmed that the film thickness of the coloring element 16 at the transmissive portion was Tt0=1.2 μm and the film thickness of the coloring element 16 at the reflective portion was Tr0=0.62 μm in those selected liquid crystal devices. Accordingly, it is desirable to set the film thicknesses of the coloring element 16 at or close to these values in manufacturing a color filter substrate 4a having the structure as shown in FIG. 2(a).

In order to obtain the film thicknesses of Tt0=1.2 μm and Tr0=0.62 μm, it is recommended that, while conducting the deposit discharge with the ink jet technology and the hotplate drying process, the material film be baked at 40 to 120° C. for approximately five minutes so as to allow the material films to go through the thicknesses of Tt1=3.9 μm at the transmissive portion, and Tr1=2.0 μm at the reflective portion, as seen in FIG. 2(b), respectively.

The color filter substrate in accordance with the present invention is used to provide a color display function in a liquid crystal device, an organic EL apparatus, or other such electro-optical apparatus. Also, the electro-optical apparatus in accordance with the present invention is preferably used as a display section of a portable phone, a portable information terminal, a PDA, or other such electronic device. Also, the electronic equipments in accordance with the present invention may be a portable phone, a portable information terminal, a PDA, or other such electronic equipment, and is particularly configured as an electronic equipment with a function whereby various data can be visually displayed.

As used herein, the following directional terms “forward, rearward, above, downward, vertical, horizontal, below and transverse” as well as any other similar directional terms refer to those directions of a device equipped with the present invention. Accordingly, these terms, as utilized to describe the present invention should be interpreted relative to a device equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A method of manufacturing a color filter substrate having a transmissive portion through which light rays are transmitted and a reflective portion on which light rays are reflected, the method comprising:
providing a transmissive base;
forming a foundation layer over the transmissive base such that a depressed portion is formed at the transmissive portion;
forming a reflective film over the foundation layer so as to have an opening at the transmissive portion;
forming banks over the reflective film so as to define a deposit region; and
forming a coloring element over the reflective film with droplet discharge onto the deposit region defined by the bank.

2. The method of manufacturing a color filter substrate as set forth in claim 1, wherein
in the forming of the coloring element, an amount of droplets to be discharged onto the discharge region is greater at the transmissive portion than at the reflective portion.

3. The method of manufacturing a color filter substrate as set forth in claim 1, further comprising rendering a surface of the bank ink repellent.

4. The color filter substrate that is produced by the method of manufacturing a color filter substrate as set forth in claim 1.

5. The method of manufacturing a color filter substrate as set forth in claim 1, wherein
in the forming of the bank, the bank is formed in a lattice, defining a plurality of deposit regions, such that the color filter has the transmissive portion and the reflective portion in each of the deposit regions.
